(19) United States
(12) Patent Application Publication
(10) Pub. No.: US 2011/0125555 A1
(43) Pub. Date: May 26, 2011

(54) FORMING ASSOCIATIONS WITHIN ONLINE COMMUNITY

(76) Inventor: Yuval Fradkin, Tel-Adashim (IL)

(21) Appl. No.: 12/953,503

(22) Filed: Nov. 24, 2010

Related U.S. Application Data
(60) Provisional application No. 61/264,669, filed on Nov. 26, 2009.

(51) Int. Cl. G06Q 99/00; G06N 5/02; G06Q 30/00; G06Q 10/00

(52) U.S. Cl. 705/7.41; 706/46

(57) ABSTRACT

A method for suggesting associations between at least two subscriber/users or WWW surfers, in which compatibility between users is calculated based upon at least compatibility of subscriber/users. Such a compatibility is calculated based upon at least one compatibility parameter. One notable parameter is a satisfaction level (SL) parameter. The SL parameter is derived in a typical case from the dwell time of the subscriber/users, associated with specific web objects.

### CROSS-REFERENCE TO RELATED PATENT APPLICATIONS

This application claims priority from U.S. Provisional patent application 61/264,669, entitled “Forming associations in online community”, filed on Nov. 26, 2009.

### FIELD OF THE INVENTION

The present invention is an implementation of social or other networks. Typically the invention relates to one or more services implemented over the Internet, which employ a search engine that collaborates with a social network.

### BACKGROUND OF THE INVENTION

Since the days the Internet communications infrastructure was made available to the general public and its usage become ubiquitous, for both private people and establishments for a variety of purposes, many applications were developed since. Online communities of people sharing at least a one common interest are now widespread and the trend continues to develop, using the Internet as a means for realizing the interconnecting. In U.S. Pat. No. 7,117,254 a description of past attempts to facilitate sensible matching is disclosed. Mutual acquaintance and online matching are dealt with in that document in more depth.

In FIG. 1 to which reference is now made, a brief scheme according to which links are facilitated by some online communities, across the network between persons is described. Person A demonstrates certain behavioural properties over time which are manifested through his/her website selection, key word selection for search etc. As person A becomes involved in an online community network, the sorting mechanism offered by the network collects the data in step 24 over at least a minimal period of time. Then the data is processed in step 26 and subsequently one to several parameters designating at least one property of the subscriber/user is produced at step 28. A second subscriber/user has his/her data collected in step 34, further processed in step 36, issuing one or more parameters numerically describing an associated property of the subscriber/user at step 38. Parameters of both respective subscribers/users A and B are compared in step 40. If a certain threshold of match has been determined in step 42, the system will issue in step 44 a proposal for connecting the two respective subscribers/users.

Formation of groups of subscribers/users having a common subject of interest is a major motivation for the present invention. The common interest as can be detected by the method of the present invention can be utilized for such an end. Examples of such groups are an assemblage of people organizing themselves for a specific trip, an assemblage of people organizing for a shared vehicle, or an assemblage people seeking association for a spiritual congregation.

A buying group is a well known association that can be formed, by implementing the ideas of the inventors. Once such a buying group is formed it can derive collective buying power form the organization and applying bidding and negotiation, as discussed in U.S. Pat. No. 6,047,266 and in US application 2008/0082420

### BRIEF DESCRIPTION OF THE DRAWINGS

FIG. 1 is a chart describing in general terms prior art method for matching subscriber/users;

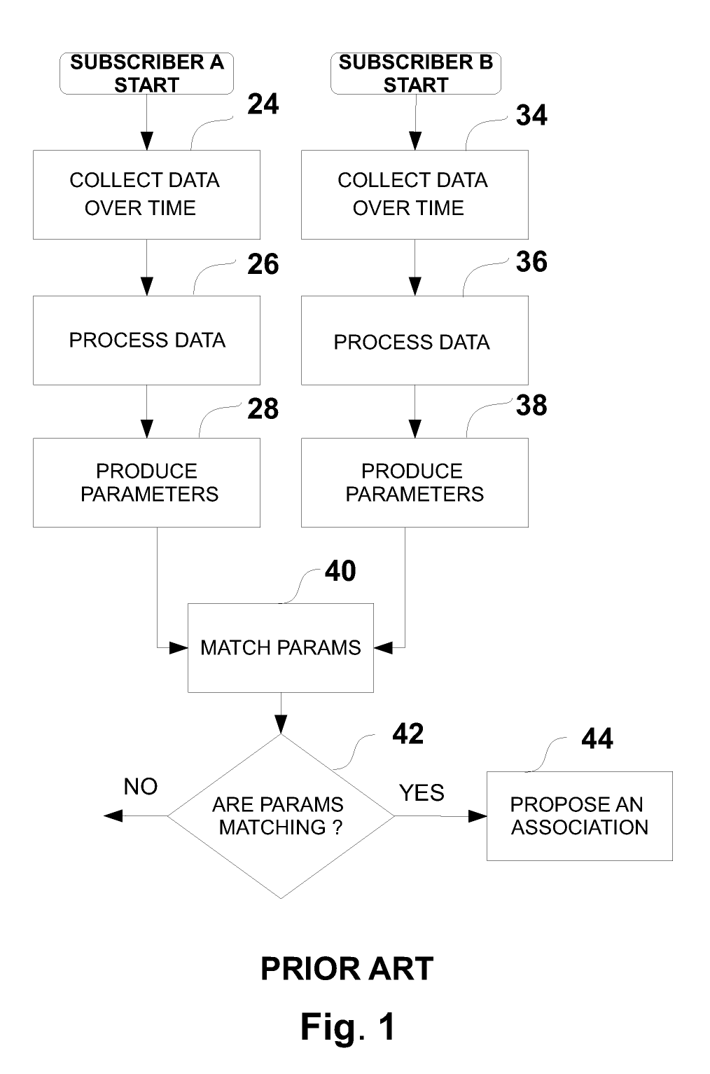

FIG. 2 is a chart describing the steps applied in accordance with an embodiment of the present invention to calculate compatibility between subscriber/users;

### DETAILED DESCRIPTION OF THE PRESENT INVENTION

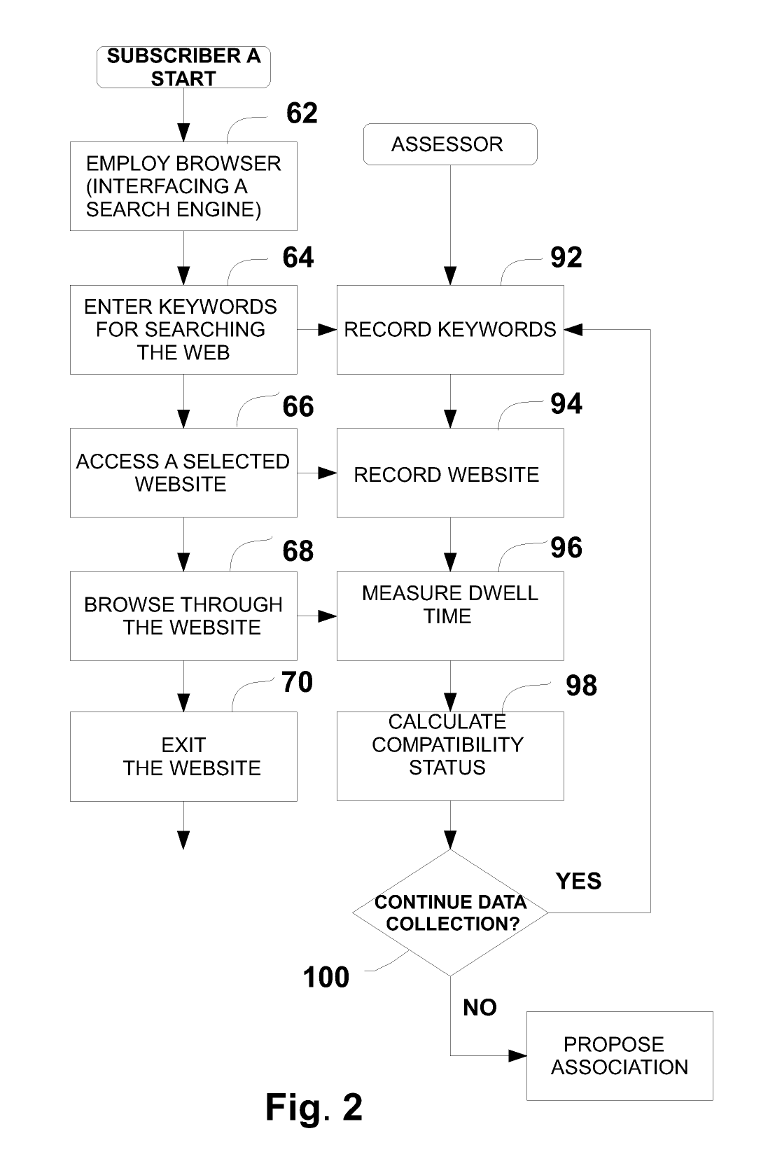

In accordance with the present invention, a social network service, referred to hereinafter as the assessor, is provided. This service aims at proposing an association between two or more different people or between groups of people in the framework of an online community, if a certain degree of similarity in some personal behavior or other characteristics is found between them. The degree of such similarity will be also referred to hereinafter as compatibility. A general simplified procedure of finding that degree of similarity (compatibility) and accomplishing a matching contest serving as grounds for issuing further recommendations in accordance with a preferred embodiment of the invention is described next, with reference to FIG. 2. Subscriber/user A employs a web browser or any other type of search engine or any Internet access tool capable of finding objects on to the world-wide-web (WWW), to connect via an end point connected to the Internet, such as a PC or a smartphone. Once a selected website is accessed in step 66, the website's pages and data become retrievable and presentable to the subscriber/user. Once the subscriber/user has finished browsing through the web pages in step 68 he/she will exit in step 70 and either quit or resume search In the meanwhile, the online network performs the task of assessing the online activity of subscriber/user A and produces one or a set of parameters to be further used in the matching of the subscriber/user with other online subscriber/user/users. It is to be mentioned at this point that the online network may be required to receive an explicit permission from the subscriber/user in order to asses his/her on-line activity. If permission is denied, the user/subscriber may be deprived of the benefits of the network service in accordance with the invention, such as the revelation of the existence of an interest group that can be beneficially offered to the user/subscriber. Due to the problematics involved with depriving the benefits of the services as described in this document, a notification can be sent to a user/subscriber, especially a newly subscribing one, that denying the network service of the ability to assess his/her on-line activity prevents the service from offering some of the merits it is credited with. As the subscriber/user employs the browser in step 64, the assessor of the social network service records the keywords used in the search and stores them in a memory at step 92. Next, the website accessed as a result of a search justifying access to a site, is recorded by the assessor in step 94 storing the information in a storage medium, and the information kept in a database, such as a relational database, relative to the information gathered about the keywords, therefore providing stored record of the keywords used and the associated websites accessed, web pages accessed, or any other accessible data or web object, such as specific images, video clips, audio data, banners and text. Next, at step 96 the assessor measures the time spent by the subscriber/user using a clock available to the assessor after entering (accessing) the website, a certain web object such as a web page, and before exiting website, or the web object, respectively, this piece of data will be hereinafter referred to as dwell time, which is kept in a memory, in a database of the user, in association with the specific web object and optionally with reference to the respective keywords. Compatibility status is then calculated in step 98 based on the data collected. The assessor then decides if more data regarding additional searches is collected and processed at step 100, adding the information to the database on storage medium, or an association may be proposed. By default, the assessor continues collecting information even if an association was already proposed. In this context, it should be pointed out that user/subscriber may be required to load some software such as a script to his/her browser or search machine in order that the assessor may be able to access the type of information that otherwise may not be available to third parties. Notably, in this respect, the addition of a specific webpage to the list of bookmarks/favorites list is a meaningful action that the assessor may take into consideration.

The assessor, or one of its modules, takes on the parameters relating to the specific web object accessed by subscriber/user A, such as the set of keywords relating to website N and matches it against an equivalent set of keywords relating to website N′ accessed by subscriber/user B. The algorithm for determining similarity will be dealt with in more detail below. When the assessor has collected information regarding a specific subscriber/user, this information can then be matched with the personal information derived from the activity of another subscriber/user, or from data supplied by explicit action, as will be discussed below.

From the point of view of communications facilitation, the users and subscribers can employ any available facility to connect to the WWW, such as personal computers connected by wire or wirelessly or any personal apparatus such as cellular telephone having a 3^{rd} generation Internet application or higher.

### The Satisfaction Level Parameter

This parameter (SL) is a level of satisfaction of a subscriber/user from a specific website or web object (explained below) accessed. The longer the dwell time of a subscriber/user with respect to a specific website, or any one of its pages or objects, the more satisfied the subscriber/user is. In another embodiment of the invention, in addition to dwell time, the SL is also measured with respect to the number of instances that the subscriber/user has accessed the same website (or one or more of its pages or any object associated with it) during a specific unit of time, this repeat parameter will be hereinafter referred to as the return rate. However, a dwell time is better computed with respect to an average dwell time of a specific subscriber/user. So that if a subscriber/user is slower in dwelling generally, the specific dwell time is to be considered rather than a general term, meaning the dwell time of a subscriber/user in a specific website (or any of its pages) is proportional to the mean dwell time of the specific person, but any other relevant statistical assessment method can be used instead of a simple average, to normalize the dwell time of the subscriber/user, or to gain information about the. In another aspect of the SL calculation, the SL related to the websites indicated as a result of a set of keywords entered to the browser and search engine, and the SL related to the actual websites accessed is measured. Thus, for a specific set of keywords, the subscriber/user may find a total number of websites which he/she accesses and the dwell time and the return rate also measured. There are two extreme possibilities in this respect, a. that the SL is measured only with respect to actual websites accessed (or specific pages of websites) and b that SL is measured with respect to sets of keywords entered by the subscriber/user without respect to the actual web pages accessed. However, it is proposed that a combination of both the websites accessed and sets of keywords submitted, each with its own SL contribute to the total SL demonstrated by a subscriber/user, in the context of calculating the compatibility status. In such cases that no websites at all were produced for a specific search, or that only a few were found, it may still be viable to form associations between users, based only on the search requests they produced. The idea is that the user of the system, expressing an interest in a specific topic is prone to associate with a matching user, who strives to receive similar information but is likewise deprived of the information. Naturally the lack of available sites or pages for a specific search does not necessarily indicate that in the future no such sites will be made available. In such cases as no websites were returned for search or searches, the notion of a potential common activity can be foreseen based on the common interest. A special form of association may be defined on the basis of repeated requests for information even though no results were received.

Another factor relating to access and dwell in websites, takes into account that the more a website is generally popular, the less the significance of an access by a subscriber/user is. Vice versa, the more specific or “professional” a website is, the more significant the access to it is.

All the above described activities relating to a website may be applied to any specific page in a website, so that a finer definitions than that of a website is applicable in the assessment of the similarity, including access and dwell relating to a web page in respect of the present invention.

The satisfaction level may be based in addition to the dwell time, also on additional factors, in combination or separately. Typically the addition of a web page to the list of “favorites” known also as list of “bookmarks” in the browser, may be used as an indication for satisfaction from the web page. In such cases as the user is allowed to rate his/her satisfaction explicitly regarding a specific item in a web page, the information thus gathered can also be used. Any other interaction made available to the user such as forwarding responses to a website in the form of emails or remarks to the website, may also be used as data for the assessment of satisfaction. Additional data for assessing satisfaction level can be collected from other interactions of user with the Internet, for example non web applications, such as FTP (file transfer protocol) applications, sharing common friends in social networks, demonstrating common interest in sharable subject matter in data sharing sites etc. Possibly, in such cases demanding more involvement in the activity of the user over the Internet, the user may be required to load an auxiliary program to his/her personal computer.

### Calculating Compatibility Status

Achieving viable compatibility calculations in order to define compatibility among subscriber/users, is a service provided by a social network in accordance with the present invention. In addition to the SL parameter discussed above, additional compatibility parameters can be used by the assessor to increase the probability of the calculated compatibility succeeding.

To mention a few such compatibility parameters, the following are typically given: age, gender, nationality, occupation, languages spoken, religion, hobbies the subscriber/user has. These may play a role in addition to the SL as described above but always in addition to it, to increase the probability of success of proposed associations. It is yet to be assessed what the weight for each such parameter is to be assigned, especially with respect to the main SL factor.

Other factors, typically personal information, can be considered by the assessor. The language of a subscriber/user bears significance with respect to the similarity level of the key word sets used for a search. Thus, a subscriber/user having a certain mother tongue would tend to use keywords in a different manner than a subscriber/user having a different mother tongue. This is a factor that tends to increase variability in a set of keywords used. However, to curb that, a set of transformation rules can be introduced to each language to decrease variability of the set of keyword, in other words to increase compatibility certainty. Similarly, the country of origin of a subscriber/user may affect the similarity level by increasing the scatter of the keywords within a set of keywords. It is well known that even between countries having the same language use, people may tend to use different words or phrases to express a common concept. Matters concerning personal information can be fed by the subscriber/user to the assessor using an online form supplied by the social network for example.

### Learning the Subscriber/User Characteristics Over Time

Over time, the assessor acquires information regarding each subscriber/user, which of the keywords entered or keyword combinations may be used to typify and refine the personal characteristics of a subscriber/user as regards the SL. Such an acquisition of information and the use of it to refine the way in which a user/subscriber is typified, can be regarded as a learning process in which additional parameters referred to above as additional compatibility parameters, such that the weight of each such parameter is weighed in the overall learning process can be incorporated.

### Appointing Experts

In another aspect of the invention, the social network offers to subscriber/users, as a service, the use of experts for specific areas of interest. The social network however examines the expert's abilities first before endorsing him/her. Accordingly, when a would-be (candidate) expert requests an endorsement by the social network, he/she would go through an examination stage, in which his/her success rate is challenged. This is done typically by letting the candidate receive online key-word sets of subscribers/users, having a compatible area of interest, without the candidate knowing the SL of the respective subscriber/user. The candidate then may recommend to a subscriber/user to access one or more websites, or even as mentioned above, specific pages in a website. The system then measures the SL factor that the sites offered by the candidate have been awarded and calculates the effectiveness of the candidate. The system may however not expect the candidate to actually advise the subscriber/user but to send the advice for assessment to the assessor, in parallel to assessing the SL of the subscriber/user. The more the advice of the candidate has provided is compatible with the actual SL of the subscriber/user, the more likely the candidate will be endorsed.

The issue of appointing or endorsing an expert can be taken further. Thus if an appointed expert is constantly measured for his/her success in increasing the SL of subscribers/users that use a specific expert the performance thus measured can be used as measure of reward or wage calculation.

In another aspect of this issue, the success of a scheme for matching specific expert/s to a specific subscriber/user is measured. Accordingly, an expert will be correlated with a SL of a subscriber/user for a specific area of interest. This also means that for this aspect, and expert is to assessed not only globally, for association with a global success rating, but in addition, with a rating of success respective of a specific subscriber/user. Gradually, a specific subscriber/user will be able to automatically allocate one or more experts with which he/she would prefer working.

### Creation of Groups of Users Having Common Interest

The processes and tools provided by implementing the present invention may be used to create groups of people having a common interest. Thus the setting up of a common interest group may be facilitated by associating a multiplicity of users based on common SL relating to websites as described above. Moreover, hierarchical sets of groupings are proposed which include main groups with more specified subgroups of more specialized interest. Thus for example, for a common interest group, such as for example “astronomy” a sub group relates to “planetary astronomy”. The internal classification based on matching degrees of SLs relating to the common denominator. In this case also, the deriving of information from specific web pages may play a role in determining compatibility and similarity. Such a grouping methodology may have impact on commercial companies, interactions between clients and providers, and flow of data in general. For example, users/subscribers who are interested in a specific cure for a disease may be connected automatically to others individuals sharing common interest, or to providers in the field or to research institutions, all based on SL of individuals acting on their own or on the behalf of larger establishments. Another example of such an application is the creation of buying groups. Such a group is assembled in order to facilitate better bargaining circumstances for the group members, and therefore better purchasing prices and/or conditions. It may be a advantage in some cases that the group is as large as possible and well organised. In such a case, the common interest as may be defined for the contested users/subscribers is the goods sought after, in the framework of a requirement of buying. Thus a buying group may be assembled from the plurality of surfers visiting an agent of a specific car model.

### Ad Hoc Groups

With the proliferation of use of cellular telephones acting as endpoints permitting access to the Internet from almost every place and at any situation, the application of the method of the present invention lends itself conveniently for the formation of ad-hoc groups of people. In this respect the term ad-hoc means that the group or association within a group is short lived, typically within the range of minutes or hours, although one cannot rule out more extended periods for such associations. Each participant joins by having demonstrated a minimal SL as he/she accesses specific sources of information over the Internet. As an example one can imagine the queuing up of audience waiting for a show and as they await the opening of the stadium, they are assessed by the assessor in accordance with the invention and each user/subscriber regarded as fit for joining a relevant ad-hoc group is admitted into the ad-hoc network group. Although cellular networking is an illustrative example for ad hoc groups formed as users use their handsets for forming the group/s, such ad-hoc groups can be formed from desktops, laptops, or a combination thereof including or excluding cellular handsets or any other wireless device performing as end points in such network group.

1. A method for suggesting associations between at least two subscriber/users or WWW surfers, in which compatibility between users is calculated based upon at least compatibility of subscriber/users, and wherein said compatibility is calculated based upon at least one compatibility parameter, said at least one compatibility parameter is a satisfaction level (SL) parameter.

2. A method for suggesting associations between at least two subscriber/users WWW surfers as in claim 1, wherein said SL parameter is derived from at least the dwell time of said subscriber/users associated with specific web objects.

3. A method for suggesting associations between at least two subscriber/users WWW surfers as in claim 1, wherein said SL parameter is derived from at least the statistical parameters of said subscriber/users associated with specific search results.

4. A method for suggesting associations between at least two subscriber/users WWW surfers as in claim 3, wherein said SL parameter is derived from at least the number of access repeats per unit time (return rate) of said subscriber/users associated with specific search results.

5. A method for suggesting associations between at least two subscriber/users WWW surfers as in claim 3 wherein said SL parameter is derived in a learning process over time.

6. A method for suggesting associations between at least two subscriber/users WWW surfers as in claim 1, wherein said association is an ad-hoc association.

7. A method for appointing experts by a social network wherein a candidate expert goes through an examination stage comprising:
said candidate receiving a key-word set of a subscribers/user from said network;
said candidate sending at least one recommendation to said subscriber/user relating to at least one web object;
the assessor of said network assesses the satisfaction level parameter of the web objects recommended by said candidate with respect to the satisfaction level obtained by the autonomous work of said subscriber, and
the assessor assessing the compatibility of said two satisfaction levels, wherein the likelihood of endorsing said expert is dependent upon said compatibility.

8. A method for rewarding an expert appointed as in claim 7 based on his/her performance in the increase of satisfaction level of a subscribers/user he/she serves.

9. A method for suggesting associations between at least two subscriber/users WWW surfers as in claim 2 and wherein said association is a buying group.

10. A method for suggesting associations between at least two subscriber/users WWW surfers as in claim 1, wherein said SL parameter is derived from at least the number of repeated requests for information of said subscriber/users associated with a specific search.

11. A method for suggesting associations between at least two subscriber/users WWW surfers as in claim 2, wherein said SL parameter is derived also from search key-words.

12. A method for suggesting associations between at least two subscriber/users WWW surfers as in claim 2, wherein said SL parameter is derived also from a list of “bookmarks” in the browser,

13. A method for suggesting associations between at least two subscriber/users WWW surfers as in claim 2, wherein said SL parameter is derived also from responses forwarded to website by a user.
